(19) United States
(12) Patent Application Publication
(10) Pub. No.: US 2005/0165610 A1
(43) Pub. Date: Jul. 28, 2005

(54) Apparatus and method for receiving a message and playing it when a control is operated

(76) Inventor: Miron Markus, Cape Town (ZA)

Correspondence Address: ROTHWELL, FIGG, ERNST & MANBECK, P.C., 1425 K STREET, N.W., SUITE 800, WASHINGTON, DC, 20005, US

(21) Appl. No.: 10/752,445

(22) Filed: Jan. 7, 2004

(51) Int. Cl. G10L 21/00

(52) U.S. Cl. 704/275

(57) ABSTRACT

The invention provides apparatus 10 and a method for receiving a message signal 34 transmitted from a remote entity, storing the message received by way of each message signal, and playing the message via a loudspeaker 16 when a switch 20 of the apparatus 10 is operated in the conventional manner.

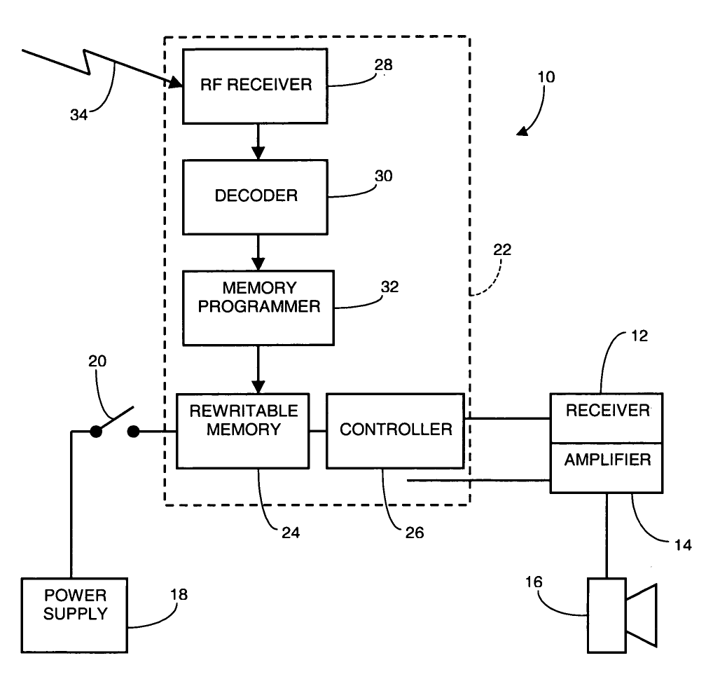

### FIELD OF THE INVENTION

This invention relates to electronic devices with sound output means, such as radio receivers. In particular, it relates to apparatus and a method for receiving a message signal transmitted from a remote entity, storing the message received in the message signal, and playing the message when an operator control is operated.

### BACKGROUND OF THE INVENTION

According to a prior method of which the applicant is aware, a message can be stored permanently in a radio receiver, to be played when the apparatus is switched on or off. If the entity from whom the message originated, such as an advertiser, wants to change the message, e.g. if there are changes in marketing trends, plans, strategies, etc., this can not be done in the apparatus of the prior method. The entity thus has no control over the replaying of the message according to the prior method.

There is a need for an electronic apparatus that can play messages to a user of the apparatus, where the messages are sent from a remote entity, and where normal use of apparatus is all that is required from the user to activate the playing of the messages.

### SUMMARY OF THE INVENTION

According to a first aspect of the invention there is provided electronic apparatus including:

a receiver for receiving message signals;

storage means for storing each message received by way of such a message signal;

an operator control whereby a conventional function of the apparatus can be controlled;

sound output means; and

control means, configured to play such a stored message, via the sound output means, whenever the operator control is operated to control the conventional function.

The operator control may be a power switch of the apparatus, and the storage means may be in the form of an integrated circuit memory device on which the message can be stored in digital form, and may be rewritable.

The apparatus may be a radio receiver and the sound output means may include a loudspeaker of the radio receiver.

According to another aspect of the invention there is provided a method of operating electronic apparatus including an operator control whereby a conventional function of the apparatus can be controlled, and sound output means, said method including:

receiving a message signal in a receiver of the apparatus;

storing each message received by way of such a message signal in storage means of the apparatus; and

playing such a stored message via the sound output means, whenever the operator control is operated to control the conventional function.

The message signal may be encoded and the method may include decoding the message signal.

The method may include playing only the most recently stored message, and/or the method may include playing a stored message at predetermined time intervals.

The method may include muting a sound that would otherwise have been produced by the sound output means, while the message is being played.

The message may be of an advertising, promotional, advertising, or advisory nature, or the like.

The invention will now be described, by way of non-limiting example only, with reference to the accompanying diagrammatic drawing.

### BRIEF DESCRIPTION OF THE DRAWING

The drawing shows a schematic diagram of a radio receiver in accordance with the invention.

### DETAIL DESCRIPTION OF THE DRAWING

Referring to the drawing, electronic apparatus in the form of a radio receiver in accordance with a preferred embodiment of the invention, is generally indicated by reference numeral 10.

The radio receiver 10 is of the type for receiving commercial broadcast transmissions and includes a conventional receiver 12, amplifier 14, and at least one loudspeaker 16, the amplifier and loudspeaker together forming sound output means. The radio receiver 10 also includes a conventional power supply 18, such as a battery, mains power supply, solar cell, or the like, for supplying electrical power to various circuit sections of the apparatus. The radio receiver 10 further includes an operator control in the form of a conventional power switch 20, disposed to connect and disconnect the power supply 18 selectively to the receiver 12 and amplifier 14.

Between the switch 20 and the receiver and amplifier circuits 12,14, there is connected a module 22 which includes an RF receiver 28, a decoder 30, a memory programmer 32, rewritable memory 24, and control means in the form of a controller 26. It is to be appreciated that parts included in the module 22 can be combined in physical components, such as combining the decoder 30 and programmer 32. The arrangement of the module 22 is such that it would be very difficult, if not impossible, to tamper with the radio receiver 10, in order to bypass the module.

The RF receiver 28 is configured to receive message signals 34, which could be encoded, from a remote source. The RF receiver 28 sends all the message signals it receives to the decoder 30, which decodes the message signals if they are encoded, and which sends the unencoded message signals to the programmer 32. The programmer 32 stores the message included in each received message signal in the rewritable memory 24.

The memory 24 is in the form of an integrated circuit, on which one or more messages can be stored in digital form in the memory 24 and each time a new message is received, a previously stored message can be deleted from the memory, so that only the most recently received message is stored in the memory. However, it is to be understood that in other embodiments of the invention, any number of messages can be stored in the memory 24. Further, each memory signal 34 can include control data, useful for controlling playing of the message.

The controller 26 is configured to feed the messages stored in the memory 24, to the amplifier 14 to be amplified an played via the loudspeaker 16, when the power switch 20 is operated. While the message si being played, the controller causes the output from the receiver 12, i.e. the sound of the normal commercial radio broadcast received in the receiver, to be muted, and to be resumed unmated after the message has been played, to allow the radio receiver 10 to operate in the normal manner.

In use, commercial messages such as advertisements, promotions, or the like, are transmitted in the form of message signals 34 from time to time by a remote entity such as a broadcaster, mobile telephone service provider, or the like. Each message signal 34 received by the RF receiver 28 is processed and the message is stored in the memory 24, as described above. When the power to the radio receiver 10 is switched on by operation of the power switch 20, the module 22 is activated and the controller 26 causes the message to be played as described above.

In the preferred embodiment, only the most recently received message is stored in the memory 24 and is played once every time the power is switched on. However, the controller 26 may be configured to play messages at predetermined time intervals while the power supply 18 remains connected, and/or to play different messages saved in the memory 24 in a predetermined or random sequence.

The sequence and timing of the playing of messages can be regulated by the controller 26 in accordance with the control data. Further, signals can be transmitted by the remote entity, which contain only control data, such as instructions to discontinue the playback of a certain message, or the like.

Radio receivers 10 that incorporate the features of the invention can be supplied as a promotional item, for free, or at a cost that is below the commercial value of such apparatus, the cost being absorbed or subsidised, e.g. as an advertising expense of an entity that stands to benefit from the transmission and/or playing of the messages.

The invention illustrated holds the advantage that a number of different messages can be played to a user of the radio receiver 10, and the playing of messages is controlled by the remote entity, while the user uses the radio receiver in the conventional manner.

1. Electronic apparatus including:
a receiver for receiving message signals;
storage means for storing each message received by way of such a message signal;
an operator control whereby a conventional function of the apparatus can be controlled;
sound output means; and
control means, configured to play such a stored message, via the sound output means, whenever the operator control is operated to control the conventional function.

2. Apparatus as claimed in claim 1, wherein the operator control is a power switch of the apparatus.

3. Apparatus as claimed in claim 1, wherein the storage means is in the form of an integrated circuit memory device on which the message can be stored in digital form.

4. Apparatus as claimed in claim 3, wherein the memory device is rewritable.

5. Apparatus as claimed in claim 1, wherein the apparatus is a radio receiver, and the sound output means includes a loudspeaker of the radio receiver.

6. A method of operating electronic apparatus including an operator control whereby a conventional function of the apparatus can be controlled, and sound output means, said method including:
receiving a message signal in a receiver of the apparatus;
storing each message received by way of such a message signal in storage means of the apparatus; and
playing such a stored message via the sound output means, whenever the operator control is operated to control the conventional function.

7. A method as claimed in claim 6, wherein the message signal is encoded and in which the method includes decoding the message signal.

8. A method as claimed in claim 6, which includes playing only the most recently stored message.

9. A method as claimed in claim 6, which includes playing the stored message at predetermined time intervals.

10. A method as claimed in claim 6, which includes muting a sound that would otherwise have been produced by the sound output means, while the message is being played.

11. A method as claimed in claim 6, in which the message is of an advertising, promotional, educational, or advisory nature.
